(19) United States
(12) Patent Application Publication
(10) Pub. No.: US 2004/0015331 A1
(43) Pub. Date: Jan. 22, 2004

(54) Remote monitoring system for chemical liquid delivery

(75) Inventors: Chris Blatt, San Diego, CA (US); Mustafa Nayfah, San Jose, CA (US); Dan Wolfe, Mesa, AZ (US); Marc Van Cleemput, Sint Niklaas (BE); Daniel Joseph Teff, Chandler, AZ (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: Arch Speciality Chemicals, Inc.

(21) Appl. No.: 10/410,628

(22) Filed: Apr. 10, 2003

Related U.S. Application Data
(60) Provisional application No. 60/372,330, filed on Apr. 12, 2002.

(51) Int. Cl. G06F 11/00; G06F 15/00

(52) U.S. Cl. 702/188

(57) ABSTRACT

A system and method for remote monitoring one or more liquid chemical delivery systems and/or tools associated with the fabrication and/or manufacturing of electronic/semiconductor components. Such a system and method allows the operator to quickly and accurately verify the status of each delivery system and tool with respect to liquid condition, alarms, problem situations, and other indications from one convenient location.

### RELATED APPLICATION

This application claims priority to U.S. Provisional Application Serial No. 60/372,330, filed on Apr. 12, 2002.

### BACKGROUND OF THE INVENTION

1. Field of the Invention

The present invention relates to a system and method for remote monitoring one or more liquid chemical delivery systems. The system allows an operator to quickly and accurately verify the status of each system with respect to liquid condition, alarms, problem situations, and other indications from one convenient location. The system and method may be utilized for monitoring and controlling high purity liquid delivery systems in the electronics/semiconductor industry from remote locations.

2. Description of the Prior Art

During the fabrication of components for the electronic and semiconductor industry there are normally multiple delivery systems containing and dispensing a variety of chemicals to tools used in the fabrication and/or manufacturing process. The chemicals supplied to the tools range from low k dielectrics to barrier materials, all designed to serve and address the low k/copper process generation during manufacturing of the components. As consumers continuously strive for lower priced electronics, the component manufacturing fabs or laboratories are driven to higher and higher levels of efficiency to successfully compete in today's market place. The most obvious sign of increasing efficiency is the shift to 300 mm wafer technology, which allows the fabs to produce more chips per unit time, thus increasing efficiency. Another aspect of the increased efficiency is maximization of tool utilization in a fab. The fab with the highest tool utilization will typically be the more cost efficient facility, as the return on investment for their assets will be maximized. Therefore, in order to keep a tool functioning at maximum efficiency, the tool must be supplied constantly with the necessary liquid chemicals and facility services.

Although there has been much activity in ensuring that the facility services such as air, exhaust, nitrogen, etc., are well supplied and monitored at all times, there has been little to no effort spent on ensuring that the liquid chemistry is constantly being supplied to the fabrication and manufacturing tools. Failure to supply the proper liquid chemistry to the tools results in the stopping of the fabrication and/or manufacturing process, therein decreasing efficiency. Therefore, the assurance that the supply of these chemistries to the tools are constant is critical for any fab to achieve the efficiency demanded in today's market.

The present invention provides a system and method that addresses the problem of properly supplying tools used during the fabrication and/or manufacturing of components for the semiconductor/electronics industry. For example, the present invention provides the operator of liquid chemical vapor deposition (CVD) tools a system and method by which they can quickly and efficiently monitor the tool status, including the tool-critical low k, high k, barrier, and other copper chemistries from one easily accessible location. The operator may therefore monitor the tools without leaving the clean room environment and can quickly determine the status of each critical chemical and delivery system.

Utilization of the system and/or method of the present invention will allow for the increased efficiency of the entire fab in a variety of ways. For example, first, a computerized system may constantly monitor all the critical liquids being delivered to the tool and alert the operators or support personnel that attention should be given to any particular system that may adversely affect the efficiency or utilization of the tool set. Second, the operator may focus on core process technology and more rapidly develop new processes for the fab without being distracted by inspecting the various systems in multiple locations. Third, additional facility staff required to monitor all the delivery system locations may be reduced as the operator can call down to a staff member and direct them quickly and efficiently to the source of the tool problem.

In addition to being able to quickly determine the level of chemistry available to the tool, the operator will be able to monitor the entire status of each system ranging from, but not limited to loss of air, loss of nitrogen, loss of exhaust, unauthorized entry, a liquid spill or leak, or temperature. A variety of independent sensors may also be installed in each tool that constantly monitor tool parameters (e.g., loss of air, loss of nitrogen, loss of exhaust, unauthorized entry, or a liquid spill or leak, temperature, etc.) and other parameters to ensure a constant and steady supply of chemistry to the tools allowing the tools to achieve its maximum efficiency.

Without the level of diagnosis provided by the present invention an operator must troubleshoot the chemical delivery system and tool by physically moving to the delivery system and the tool. Since the delivery system and tool are normally in different locations, a large time commitment is required. The troubleshooting duration is lengthened because chemical delivery systems are normally located in the sub-fab area where the price per square foot is much lower than that in the clean room. The clean room is where the operators of the tool systems typically reside and work. In order for an operator to inspect the delivery system, the operator may normally travel not only a long distance, but through several floors and through several clean room boundaries. Entry and exit from a clean room requires the operator to remove their clean room suit. The operator must then investigate the delivery systems in the sub-fab, and then upon returning to the clean room, re-apply their clean room suit. Clearly, this costs valuable time and money, not only in moving between areas, but in clothes and garments that need to be re-issued. Again, the system of the present invention allows rapid and accurate diagnosis of the situation, which will allow the situation to be fixed quickly. Historically, without this level of diagnosis, the operator may spend countless hours investigating all other areas and eliminating them one by one until the operator discovers the problem.

### SUMMARY OF THE INVENTION

The present invention provides a system and method for monitoring support and chemical delivery systems associated with tools used in the fabrication and/or manufacture of electronic/semiconductor components. This system and method are capable of monitoring parameters associated with tools used in the fabrication and/or manufacturing of components in the electronics/semiconductor industry.

A system for monitoring chemical delivery to at least one tool, according to an embodiment of the present invention, includes an interface; at least one chemical delivery system in communication with the interface; and at least one tool connected to the chemical delivery system.

A method for monitoring the chemical delivery to a tool, according to an embodiment of the present invention includes the steps of sensing the status of at least one parameter of a chemical delivery system and/or at least one parameter of the tool; communicating the status to a computer; and analyzing the status to determine whether the parameters of the chemical delivery system and or the tool are within a predetermined range.

The present invention also provides a system and method, which is capable of utilizing a monitoring system that enables an operator to monitor tool parameters and troubleshoot error conditions from a remote location. This can be accomplished via a screen that will allow an operator to monitor the parameters of a number of fabrication tools from a single location.

### BRIEF DESCRIPTION OF THE DRAWINGS

FIG. 1 is a perspective view of a system in accordance with a preferred embodiment of the present invention;

FIG. 2 shows an example of a computer screen display identifying the tool parameters and chemical delivery system parameters for a tool of the present invention;

FIG. 3 shows another example of a computer screen display identifying the status of chemical delivery system parameters for four tools of the present invention;

FIG. 4 shows another example of a computer screen display identifying four chemical delivery systems of the present invention;

FIG. 5 shows a pictorial overview of the another embodiment of the present invention; and

FIG. 6 is a block diagram showing a method for remote monitoring of a process according to the present invention.

### DETAILED DESCRIPTION OF THE INVENTION

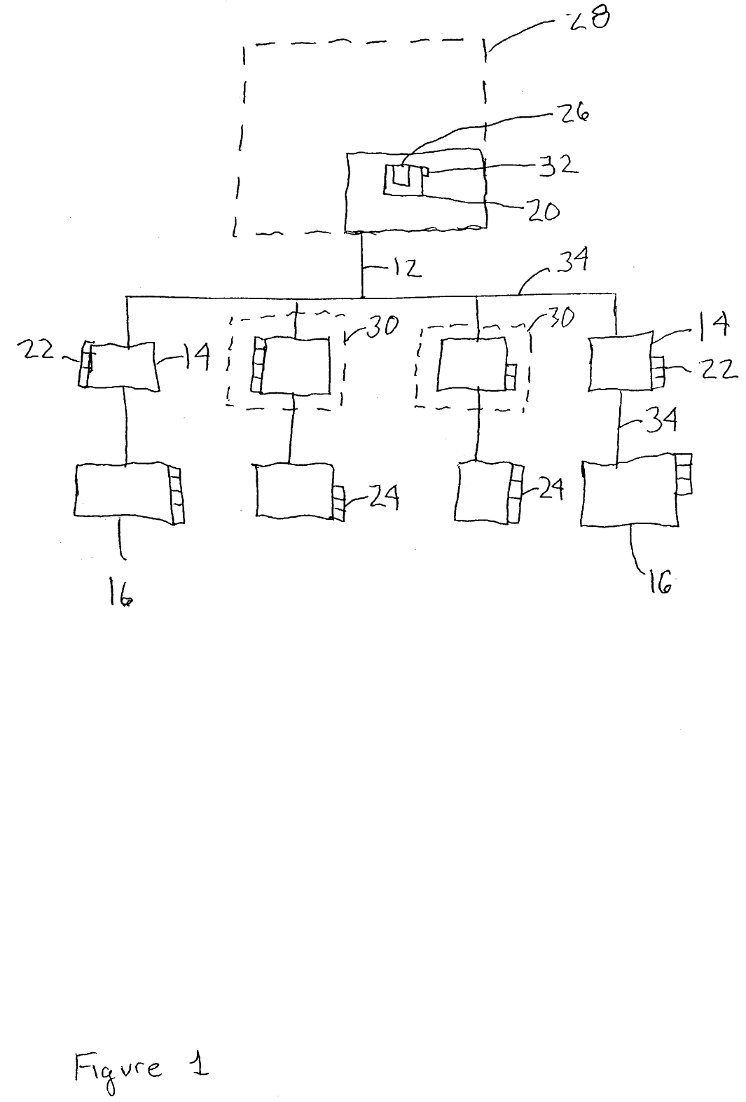

Referring to FIG. 1, one embodiment of the remote monitoring system 10 of the present invention may include a computer interface 12 connected to a chemical delivery system 14 for a tool 16. The computer interface 12 may be routed via cable 34 or wireless technology (not shown) back to a central processing station 18. The central processing station 18 may include a computer 20.

The system 10 may include delivery sensors 22 that monitor parameters associated with the chemical delivery system 14. Signals from the delivery sensors 22 may be sent via the cables 34 and computer interface 12 to the computer 20 for display on a computer screen 26. The delivery sensors 22 may monitor any suitable parameters associated with the chemical delivery system 14 including liquid container volume, container pressure status, exhaust status, door status, spill, leak, etc. The chemical delivery systems 14 may include a number of liquid containers depending on the tool 12 serviced by the delivery system 14.

The system 10 may also include tool sensors 24 that monitor any suitable parameters associated with the tool 12 including air pressure, nitrogen pressure, temperature, liquid spill, or leak, etc. The tools sensors 24 may be connected to the central processing station 18 via the computer interface 12 and routed via cable 34 or wireless technology (not shown) back to the central processing station 18. The tool sensors 24 allow for the tool to be constantly monitored and may help ensure a steady supply of chemistry to the tool, therein allowing the tool to achieve maximum efficiency.

The signals from both sensors 22, 24 may be displayed on a computer screen 26 of the computer 20. The screen 26 may display the parameters of the tool 16 and delivery system 14 monitored by the monitoring system 10. The central processing station 18 may be located in a clean room 28 whereas the tool cabinets 30 associated with the delivery systems 14 may be located in an area away from the clean room 28. The remote monitoring system 10 may be configured to monitor any number of tools 16 and delivery systems 14 by configuration of any necessary interfaces 12 or cables 34 to the monitoring system 10.

The monitored parameters may be displayed on a single computer display screen 26 to therein allow the operator to monitor all tool parameters and delivery system parameters from one screen 26. The remote monitoring system 10 therefore allows the operator to quickly scan each tool 16 and the parameters of delivery systems 14 by looking at the screen 26 and to detect any problems associated therewith since the central processing station 18 constantly monitors the delivery systems 14.

Should a condition occur in any one of the tools 16 or delivery systems 14, the computer system 20 will quickly detect the problem and alert the operator by displaying a visual indication on the screen 26 or the system may include an alarm 32 for signaling an audio alarm. The operator may then identify the indicated parameter for the specific tool or delivery system to a support person in order for the support person to diagnose the problem.

For example, any one of the following occurrences could precipitate a visual indication or alarm signal including low liquid level, low exhaust level, loss of air, loss of nitrogen, high temperature, liquid spill, or leak. When the indication or alarm is triggered, the signal may then be quickly identified by the operator on the screen 26. The operator may then select the delivery systems 14 showing the problem from the computer 20 and review all the parameters of delivery systems 14 pertaining to those delivery systems 14 which caused the signal such as liquid level, exhaust level, temperature, entry status, etc. A support person may then be contacted by the operator and notified of delivery systems 14 experiencing the problem. The situation may then be solved immediately ensuring and protecting the chemical supply to the tool, thus, maximizing the tool utilization and creating a more efficient fab. The same troubleshooting procedures may be followed if the indication is caused by a signal sent from a tool sensor 24.

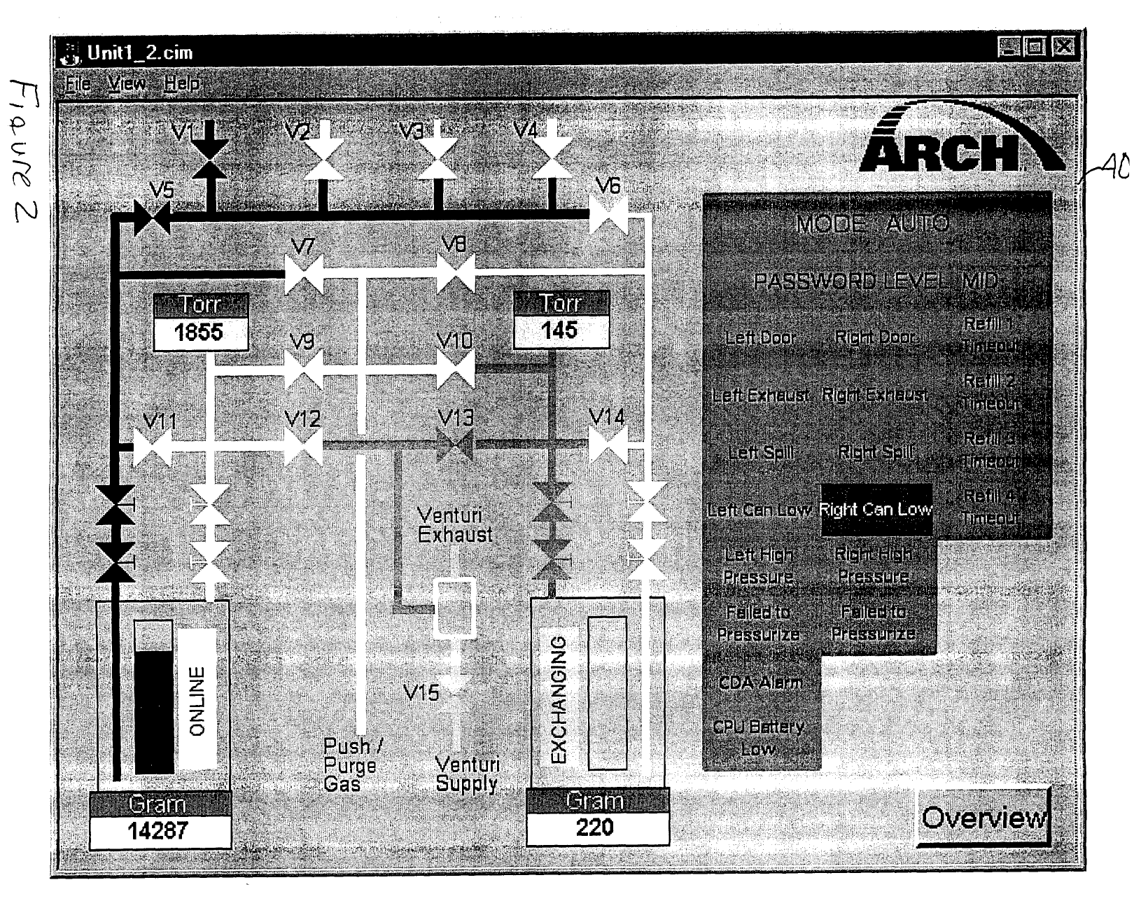

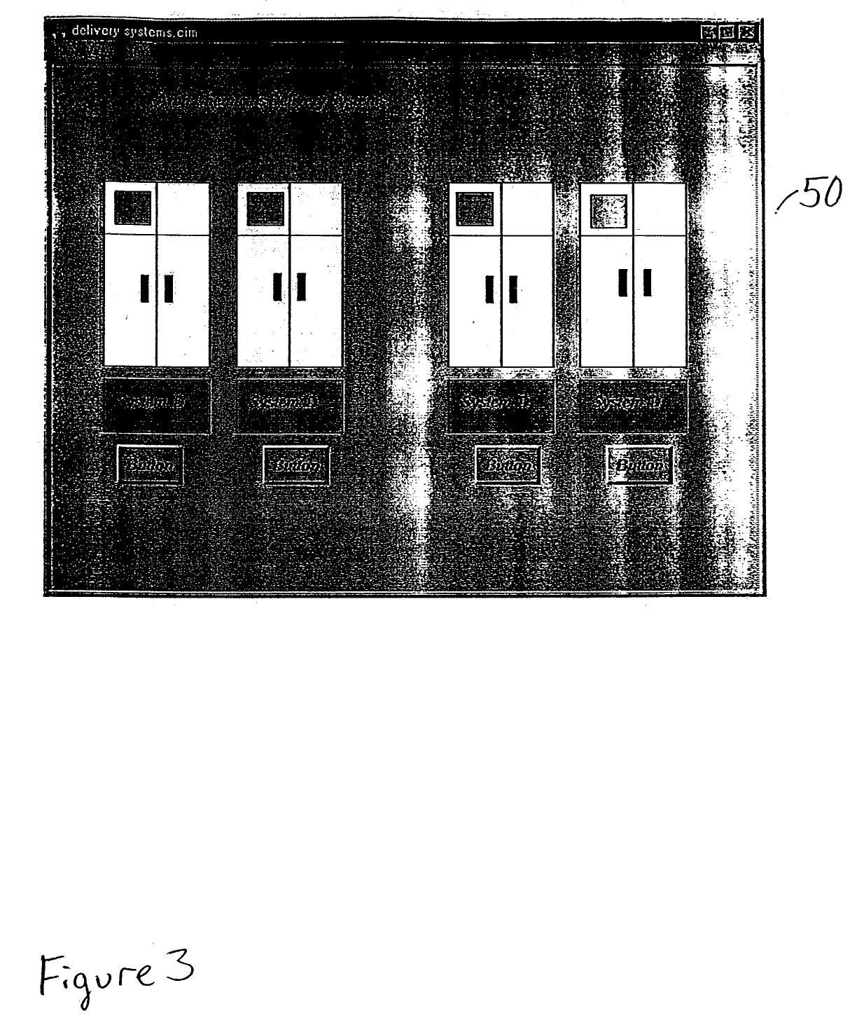

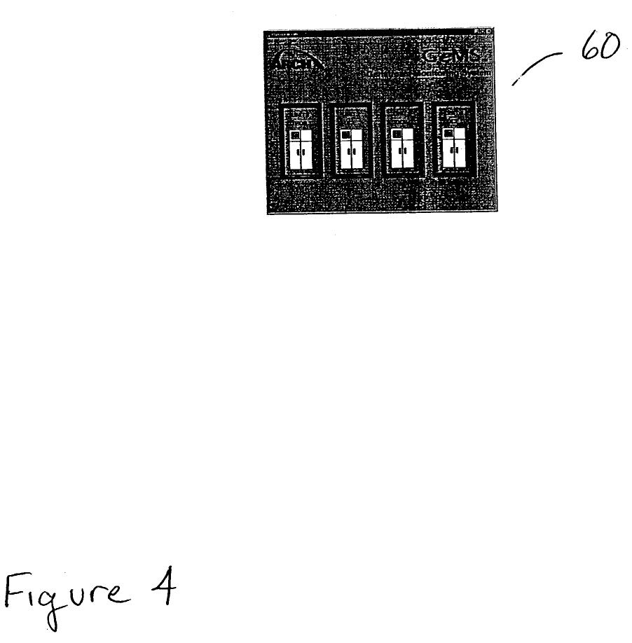

With reference to FIG. 2, an example 40 of a computer screen display identifying the tool parameters and chemical delivery system parameters for a tool of the present invention is shown. The display identifies the chemical delivery system and also the status display indicators for the chemical delivery system. The status indicators for the chemical delivery systems may include indications for Left Cabinet Empty (L.C. empty), Left Door (L. Door), Left Spill (L. Spill), etc. The display may be configured based on the type of tool and the type of chemical delivery system being utilized. FIG. 3 shows another example 50 of a computer screen display identifying the status of chemical delivery system parameters for four tools of the present invention. The four tool cabinet symbols may be used to identify the chemical delivery system of the tool. FIG. 4 shows another example 60 of a computer screen display identifying four chemical delivery systems of the present invention. The displays may be configured by the operator to maximize efficiency.

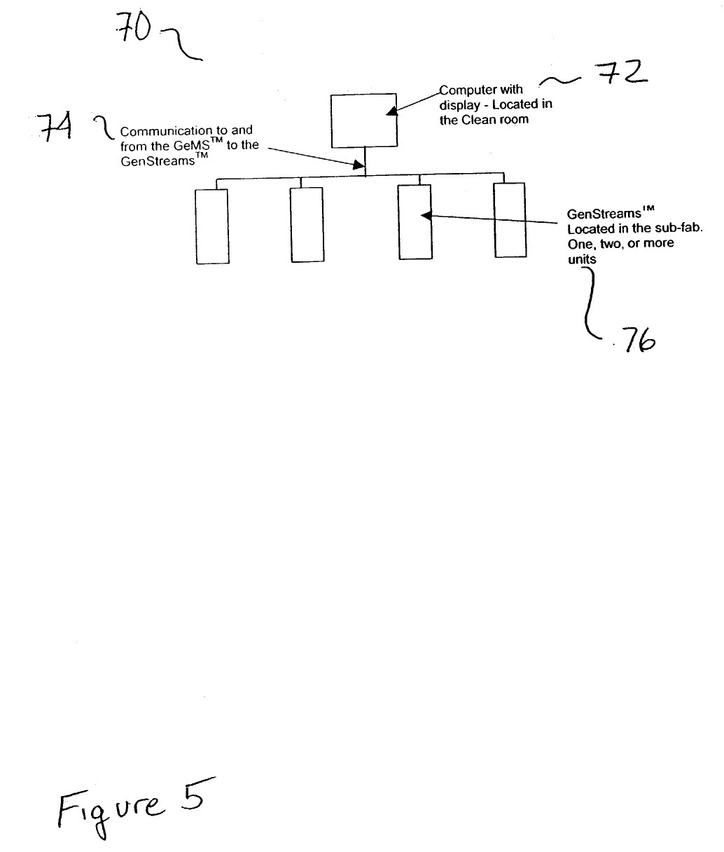

Referring to FIG. 5, another embodiment of the remote monitoring system 70, or GeMS™ System, may include, but is not limited to, the following equipment. Computer system 72, with user interface for input and visual and audio outputs, has communication connections 74 to the various GenStream™ systems 76. The communication connections may be either wired or wireless. Associated hardware is installed in the GenStream™ systems to allow for communication back to the GeMS™ system 76.

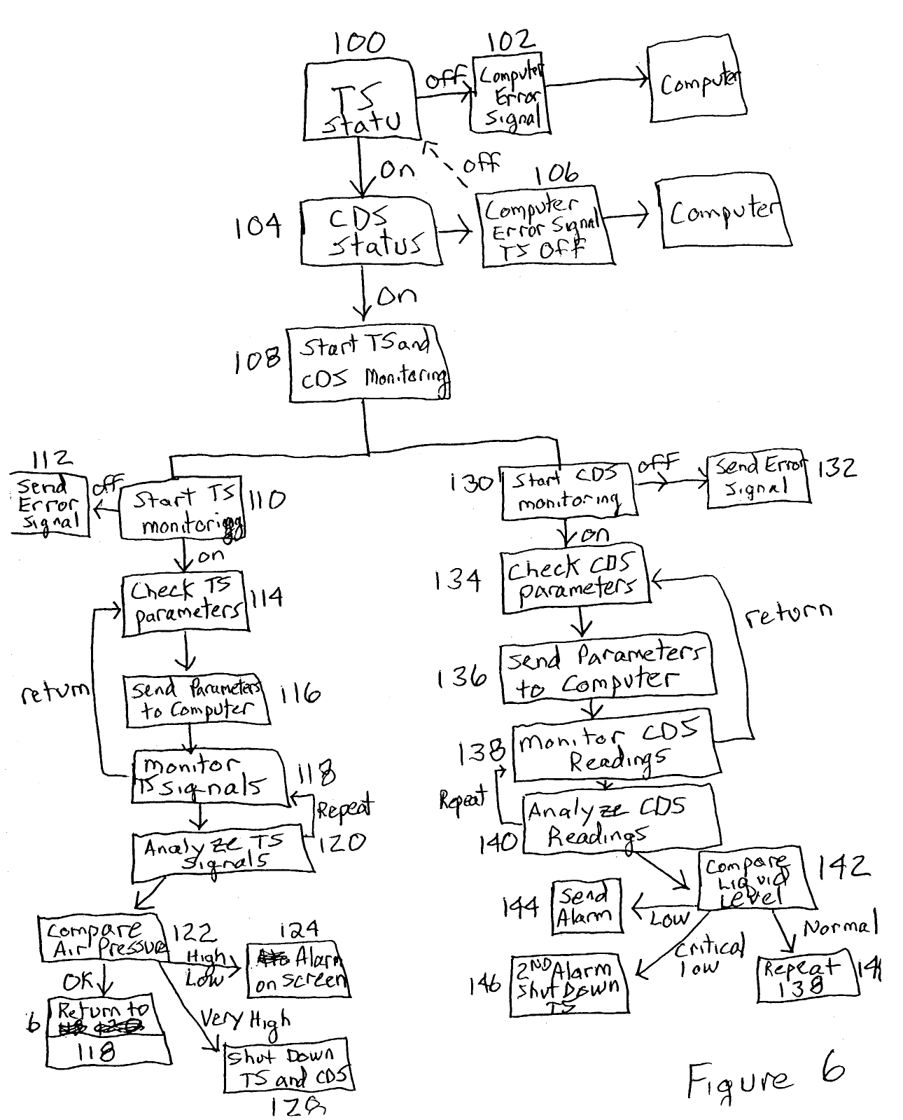

Referring to FIG. 6, a logic and block diagram shows another embodiment of the system and method of the present invention. The monitoring system of the present invention may include a computer that monitors the status of the tool and chemical delivery system. The program includes the following steps, which will monitor the tool system (TS) and chemical delivery system (CDS). Logic block 100 checks the TS status. If the TS is not working, then block 102 generates an error signal to the computer. If the TS is working, then block 104 checks the CDS status. If the CDS is not working, then block 106 generates an error signal to the computer and generates a signal to turn off the TS.

The next step is to begin the monitoring of the TS and CDS as shown in block 108. Block 1 10 shows the start of the TS monitoring. If the TS monitoring does not function, then an error signal identifying the problem is sent to the computer as shown in block 112. If the TS monitoring begins, then the next step is to check the parameters to be monitored on the TS. For example, block 114 shows the monitoring of the TS parameters by the tool sensors including for example, air pressure, nitrogen pressure, exhaust status, temperature, etc. The parameter readings are sent to the computer as seen in block 116. The computer monitors the signals as shown in block 118 and then analyzes each signal. Block 120 shows that the readings are then analyzed.

All of the TS parameters may be analyzed in order to determine whether the parameters are within an acceptable range or status. For example, blocks 122 through 126 show the analyzing of the air pressure. Block 122 shows the air pressure compared to the normal TS air pressure range. Block 124 shows that if the TS air pressure is too high or too low a signal is sent to send an alarm to flash an alarm on the computer screen. Block 126 shows that if the reading is within an acceptable range, the next reading is analyzed by returning to block 118. These same types of analysis steps may be repeated for any other TS parameters (e.g., nitrogen pressure, exhaust pressure, etc.). In some instances an alarm signal and a shut down signal will be sent to the TS and the CDS if a parameter is out of a particular range, as shown in block 128.

Block 130 shows the start of the CDS monitoring. If the CDS monitoring does not function, then an error signal identifying the problem is sent to the computer, as shown in block 132. If the CDS monitoring begins, then the next step is to check the parameters to be monitored on the CDS. For example, block 134 shows the monitoring of the CDS parameters by the delivery sensors including, for example, Left Cabinet Empty, Left Door status, Left Can status, etc. The parameter readings are sent to the computer as seen in block 136. The computer monitors the signals as shown in block 138 and then analyzes each signal. Block 140 shows that the readings are then analyzed.

All of the CDS parameters may be analyzed to determine whether the parameters are within an acceptable range or status. For example, blocks 142 through 148 show the analyzing of the liquid level of a chemical that is sent to the tool. Block 142 shows the liquid level compared to the normal CDS liquid level range. Block 144 shows that if the CDS liquid level is too low, then an alarm signal is sent to the computer screen. Block 146 shows that if the liquid level is critically low, then a different alarm signal is sent to the screen and a shut down signal is sent to the tool. Block 148 shows that if the reading shows that the liquid level is above normal, then the next reading is analyzed by repeating block 138 for new readings. Similar analysis steps may be repeated for the other CDS parameters (e.g., left cabinet status, left door entry status, spill status, etc.). In some instances, an alarm signal and a shut down signal will be sent to the TS and the CDS if a specific parameter is out of a normal range and a critical failure could occur with the TS and or the CDS.

FIG. 6 is one example of a block and logic diagram for the present invention. The parameters are continuously read by the TS and CDS sensors and analyzed by the computer during the system operation.

The present invention having been thus described with particular reference to the preferred forms thereof, it will be obvious that various changes and modifications may be made therein without departing from the spirit of the present invention.

We claim:

1. A system for monitoring chemical delivery to at least one processing tool, the system comprising:
an interface;
at least one chemical delivery system in communication with said interface; and
at least one tool connected to said chemical delivery system.

2. The system of claim 1, wherein said system is a remote monitoring system.

3. The system of claim 1, wherein said at least one processing tool is at least one semiconductor processing tool.

4. The system of claim 1, further comprising a central processing unit connected to said interface.

5. The system of claim 4, wherein said central processing unit communicates with said interface by at least one cable.

6. The system of claim 4, wherein said central processing unit communicates with said interface via wireless communications.

7. The system of claim 1, further comprising at least one sensor for monitoring at least one parameter of said at least one chemical delivery system.

8. The system of claim 7, wherein said parameter is at least one selected from the group consisting of: volume, pressure, exhaust, door status, spill, leakage, and temperature.

9. The system of claim 7, wherein said at least one sensor communicates a signal to said interface.

10. The system of claim 1, wherein said chemical delivery system comprises at least one container, which is capable of storing chemical.

11. The system of claim 1, further comprising at least one tool sensor in communication with said interface.

12. The system of claim 11, wherein said at least one tool sensor is capable of monitoring at least one tool parameter.

13. The system of claim 12, wherein said tool parameter is at least one selected from the group consisting of: pressure, temperature, spills, leaks, volume, and flow rate.

14. The system of claim 4, wherein said central processing unit is located in a clean room.

15. A method for monitoring the chemical delivery to a tool, the method comprising the steps of:
sensing the status of at least one parameter of a chemical delivery system and/or at least one parameter of said tool;
communicating said status to a computer; and
analyzing said status to determine whether the parameters of said chemical delivery system and/or said tool are within a predetermined range.

16. The method of claim 15, wherein said status of said chemical delivery system and/or said tool is monitored with at least one sensor in communication with said computer.

17. The method of claim 15, wherein said computer is located remote to said tool.

18. The method of claim 15, wherein said tool is at least one semiconductor processing tool.

19. The method of claim 15, wherein said computer is located in a clean room.

20. The method of claim 15, wherein said parameter of said chemical delivery system is at least one selected from the group consisting of: volume, pressure, exhaust, door status, spill, leakage, and temperature.

21. The method of claim 15, wherein said parameter of said tool is at least one selected from the group consisting of: pressure, temperature, spills, leaks, volume, and flow rate.

22. The method of claim 15, wherein said status is communicated to said computer through an interface.

23. The method of claim 22, wherein said interface is in communication with at least one sensor on said chemical delivery system and/or said tool by a connecting means selected from the group consisting of: cables, wireless means, and a combination thereof.
